(19) United States
(12) Patent Application Publication
(10) Pub. No.: US 2025/0005574 A1
(43) Pub. Date: Jan. 2, 2025

(54) RECOVERABLE TRANSACTIONS IN BLOCKCHAIN SYSTEMS VIA WRAPPED RECOVERABLE TOKENS

(71) Applicant: Circle Internet Financial Limited, Dublin (IE)

(72) Inventors: Keri Kaili WANG, Brooklyn, NY (US); Erik TIERNEY, Lexington, MA (US)

(21) Appl. No.: 18/346,073

(22) Filed: Jun. 30, 2023

(51) Int. Cl. G06Q 20/40; G06Q 20/36; G06Q 20/38

(52) U.S. Cl. CPC G06Q 20/4014; G06Q 20/363; G06Q 20/389

(57) ABSTRACT

Certain aspects of the present disclosure provide techniques and apparatus for processing recoverable transactions on a blockchain. An example method generally includes receiving a request to execute a transaction on a blockchain to transfer a quantity of a wrapped token which encapsulates a base token exchanged in transactions on the blockchain. A running total of tokens in the receiver wallet that are in a recoverable state is incremented by the quantity of the token identified in the request. After a threshold amount of time from a timestamp associated with the received request, it is determined whether the transaction has been frozen. Based on determining that the transaction has not been frozen, the running total of tokens in the receiver wallet that are in the recoverable state is decremented, and a running total of tokens in the receiver wallet that are in a non-recoverable state is incremented.

### INTRODUCTION

Aspects of the present disclosure relate to security in blockchain systems, and more specifically to recoverable transactions in blockchain systems.

### BACKGROUND

Blockchains can be used in various decentralized systems to provide a ledger of transactions that have occurred within these decentralized systems. Generally, a blockchain may include a chain of blocks, in which latest block includes some information about a transaction that occurred and a reference to an immediate predecessor block, which may be a hashed value of the previous block. Because the reference to the immediate predecessor block may be a value derived from the immediate predecessor block, verification of the transactions in the blockchain may be performed by ensuring that a hash of a block resolves to the same value as that stored as a reference to the immediate predecessor block in a succeeding block in the blockchain. If there is a mismatch between a computed hash of a block and the hashed value of the block in a succeeding block in the blockchain, validation of the blockchain may fail.

Generally, transactions recorded on a blockchain are immutable and irreversible once recorded and validated on the blockchain. Because transactions recorded on a blockchain are immutable and irreversible, the blockchain may be considered a source of truth for transactions that are recorded on the blockchain. Thus, performing transactions on a blockchain may allow for trust to be established between potentially unknown parties performing transactions on the blockchain. For example, the source of tokens transferred between parties on the blockchain may be trusted by virtue of users participating in these transactions recording such transactions on the blockchain.

However, the immutability and irreversibility of transactions on the blockchain may also create various security risks. For example, in a 51% attack, the transaction records stored on a blockchain may be modified if more than half of the nodes participating in processing transactions on the blockchain include a false record. In another example, because of the immutability and irreversibility of transactions on the blockchain, transactions that occur due to malicious attacks (e.g., transfers of tokens to attackers who demand cryptocurrency payments in order to reverse the effects of a ransomware attack) may not be reversed, and the victims of such attacks may not be able to recover tokens that are lost due to such attacks.

Accordingly, techniques are needed to improve the security of transactions occurring on the blockchain.

### BRIEF SUMMARY

Certain embodiments provide a computer-implemented method for processing recoverable transactions on a blockchain. An example method generally includes receiving a request to execute a transaction on a blockchain. The request generally includes a request to transfer a quantity of a token on the blockchain from a transmitter wallet to a receiver wallet identified in the request, and the token generally is a wrapped token encapsulating a base token exchanged in transactions on the blockchain. A running total of tokens in the receiver wallet that are in a recoverable state is incremented by the quantity of the token identified in the request. After a threshold amount of time from a timestamp associated with the received request, it is determined whether the transaction has been frozen. Based on determining that the transaction has not been frozen, the running total of tokens in the receiver wallet that are in the recoverable state is decremented by the quantity of the token, and a running total of tokens in the receiver wallet that are in a non-recoverable state is incremented by the quantity of the token.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing system in which recoverable transactions are performed on a blockchain using wrapped tokens, according to embodiments of the present disclosure.

FIG. 2 illustrates a timeline for executing a recoverable transaction on a blockchain using wrapped tokens, according to embodiments of the present disclosure.

FIG. 3 illustrates example operations for executing a recoverable transaction on a blockchain using wrapped tokens, according to embodiments of the present disclosure.

FIG. 4 illustrates an example system on which embodiments of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Transactions in cryptocurrency systems may be represented as blocks in a blockchain that track a universe of transactions performed using the cryptocurrency system. In these cryptocurrency systems, processed transactions may not be modified at a later date, thus providing an immutable ledger of the transactions performed using the cryptocurrency system.

Using blockchain systems to perform and record transactions generally allows for transactions to be immutably recorded, which may allow for the blockchain to provide a consistent, unmodifiable record of transactions that have occurred on the blockchain and thus a consistent, unmodifiable transaction history for each user performing actions on a blockchain. The immutability and irreversibility of transactions on a blockchain, however, may allow malicious parties to perform malicious transactions that cannot be reversed. For example, hacks on wallets, transactions occurring due to scams executed against a wallet owner, thefts of tokens from wallets, and other attacks against wallets may occur from time to time, and the immutability and irreversibility of transactions performed on a blockchain may prevent victims from recovering tokens lost due to such attacks. Thus, transaction security and trust in a blockchain system may be negatively impacted by the immutability of a blockchain system and the irreversibility of transactions executed on blockchain systems.

Aspects of the present disclosure provide techniques for performing recoverable transactions on a blockchain using wrapped tokens. As discussed in further detail herein, a wrapped token may encapsulate a defined base token and allow for the wrapped token to be in a recoverable state, a non-recoverable state, or a frozen state. Generally, a wrapped token may be received at a wallet in a recoverable state and remain in a recoverable state until some threshold amount of time has elapsed. While the wrapped token is in a recoverable state, the wrapped token may be frozen (e.g., based on an indication, performed by a trusted source, that the wrapped token was involved in a fraudulent transaction subject to reversal). When the wrapped token is placed in a non-recoverable state, the wrapped token may be unwrapped, and the base token may be recovered from the wrapped token. By using wrapped tokens which can be in a recoverable state or non-recoverable state in transactions performed on a blockchain, aspects of the present disclosure may allow for transactions to be reversed in various cases where a transaction is determined to be fraudulent or the result of malicious activity. Thus, aspects of the present disclosure may improve security and trust in blockchain systems, as malicious transactions may be reversed, reducing the likelihood that parties to transactions performed on a blockchain will permanently lose tokens or other digital assets due to malicious transactions or malicious parties performing transactions on the blockchain.

### Example Recoverable Transaction Processing on a Blockchain Using Wrapped Tokens

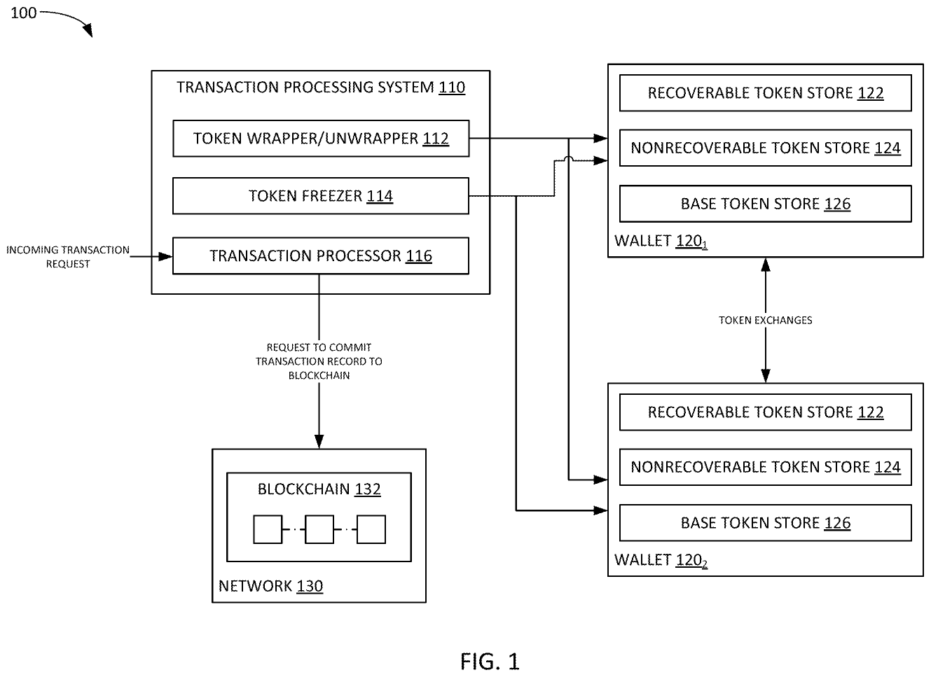

FIG. 1 illustrates an example computing environment 100 in which recoverable transactions are performed on a blockchain using wrapped tokens, according to aspects of the present disclosure. As illustrated, computing environment 100 includes a transaction processing system 110, a plurality of wallets 120, and a network 130.

Transaction processing system 110 generally allows for recoverable tokens to be generated and destroyed by wrapping a base token into a wrapped token, freezing recoverable tokens, and executing recoverable transactions on blockchain 132 on network 130. As illustrated, transaction processing system 110 includes a token wrapper/unwrapper 112, token freezer 114, and transaction processor 116.

Token wrapper/unwrapper 112 generally allows for a user associated with a wallet 120 to wrap base tokens into a wrapped token and to unwrap base tokens from wrapped tokens to allow for recoverable transactions to be performed on blockchain 132. Generally, recoverable transactions may be performed using wrapped tokens, while nonrecoverable transactions may be performed using base tokens.

A wrapped token generally allows for recoverability data to be added to a base token that may be used to perform transactions recorded on a blockchain. The recoverability data may include a recoverability status indicator and a frozen status indicator. The recoverability status indicator may be, for example, a Boolean value, with Boolean TRUE equating to the wrapped token being recoverable and Boolean FALSE equating to the wrapped token being nonrecoverable. Similarly, the frozen status indicator may also be a Boolean value, with Boolean TRUE equating to the wrapped token being frozen (and thus a token included in a transaction subject to reversal) and Boolean FALSE equating to the wrapped token being non-frozen.

When a user initially creates a wrapped token in wallet 120 based on a base token (e.g., from base token store 126 in wallet 120), the wrapped token may be initialized in a non-recoverable and non-frozen state. That is, because it may be assumed that the user owns the tokens which are being wrapped through token wrapper/unwrapper 112, the tokens need not be placed in a recoverable state and are not able to be frozen. After creating the wrapped token, the wrapped token may be added to nonrecoverable token store 124 in wallet 120.

Token wrapper/unwrapper 112 also allows a user to convert wrapped tokens back to the base token encapsulated in the wrapped token. Generally, a user may be allowed to unwrap tokens in a non-recoverable state (e.g., token in nonrecoverable token store 124 in wallet 120) into a base token and add the unwrapped base tokens to base token store 126 in wallet 120. Token wrapper/unwrapper 112, however, may not allow users to unwrap recoverable tokens in recoverable token store 122, as these tokens may be frozen in the event that transactions involving these tokens are may be subject to reversal until a threshold amount of time from the timestamp associated with the transaction has elapsed.

Token freezer 114 generally serves as a governance source that allows for tokens to be frozen when transactions performed on blockchain 132 in network 130 are determined to be potentially fraudulent or malicious (e.g., a transaction corresponds to a token theft event, malicious activity such as a ransomware attack in which cryptocurrency is used to obtain a decryption key to reverse the ransomware attack, etc.) and thus subject to reversal. When token freezer 114 determines that a transaction performed on blockchain 132 is a fraudulent or malicious transaction, token freezer 114 can flip the frozen status (e.g., change the frozen status from Boolean FALSE to Boolean TRUE) of the tokens involved in the transaction and stored in transmitter wallet 1202. After freezing the tokens, token freezer 114 (or some other external governance source) can reverse the transaction or instruct transaction processor 116 to reverse the transaction. In reversing the transaction, the frozen tokens may be withdrawn from recoverable token store 122 in transmitter wallet 1201 and returned to the sending wallet 1202.

In some aspects, the threshold amount of time for a transaction to be reversed, and thus for freezing the tokens involved in a transaction that subject to reversal, may be defined globally (e.g., for all transactions executed through transaction processing system 110). In some aspects, the threshold amount of time for a transaction to be reversed may be defined according to policies associated with each recipient wallet. In such a case, token freezer 114 can maintain lists associated with each recipient wallet including transactions that are subject to reversal.

Generally, lists of transactions maintained by token freezer 114 for determining when transactions are subject to reversal may be organized chronologically (e.g., in a first-in, first-out data structure). As time progresses, transactions at the front of the data structure (e.g., the earliest transactions) may be finalized by determining whether the transaction is potentially fraudulent/malicious and thus subject to reversal. As discussed, these transactions may be processed according to a threshold amount of time defined for a transaction (which may be a global threshold defined for all transactions executed through transaction processing system 110 or a per-recipient-wallet threshold defined for transactions executed with a particular transmitter wallet 120). As time elapses, and as transactions are finalized, the list of transactions pending finalization may be adjusted to reflect which transactions are still pending finalization and which transactions have been finalized. In some aspects, the list of transactions maintained by token freezer 114 may be updated periodically (e.g., at the end of each day), which may allow for large quantities of transactions to be removed from the list in a single operation to reduce network and processing overheads involved in removing individual transactions from the list as such transactions are finalized. In such a case, token freezer 114 can traverse the list of transactions to identify the next transaction pending finalization and can update and/or verify the number of tokens in recoverable token store 122 based on the number of transactions pending finalization for the user associated with transmitter wallet 1201.

In some aspects, token freezer 114 can freeze tokens associated with a transaction subject to reversal based on validation of a token freezing operation executed on blockchain 132. In such a case, token freezer 114 and other participants in processing transactions on blockchain 132 can vote on whether a transaction should be subject to reversal and thus whether the tokens associated with the transaction are to be frozen. If multiple governance authorities (including token freezer 114) votes, on the blockchain, that a transaction should be reversed, token freezer 114 can freeze the tokens in transmitter wallet 1201 associated with the transaction. Performing on-chain validation and reversal of fraudulent or malicious transactions via multiple governance authorities may allow for increased trust in decisions to reverse a transaction and freeze the tokens associated with the transaction, as a determination that a transaction is fraudulent or malicious and thus is subject to reversal may be made by multiple parties, a substantial number of which may need to be compromised in order to compromise the legitimacy of transaction records on the blockchain 132 (e.g., more than 50 percent of nodes processing transactions on the blockchain).

In some aspects, token freezer 114 can freeze tokens associated with a transaction determined to be a fraudulent or malicious transaction across multiple wallets. For example, assume that a malicious transaction has occurred, with transmitter wallet 1202 having transmitted a quantity tx0 of tokens to transmitter wallet 1201, and a plurality of additional transactions have occurred downstream of transmitter wallet 1201 with quantities tx1, tx2, and tx3. Token freezer may freeze, at each wallet having received tokens downstream of the transmitter wallet 1201, a quantity of tokens that does not exceed the minimum of (|tx0|, |tx1|, |tx2|, |tx3|) or the number of tokens available at each of the wallets to which the plurality of additional transactions have occurred. The frozen transactions may be established such that the malicious transaction is the earliest transaction and has occurred prior to the expiry of a time window defined based on the threshold amount of time in order to reverse a transaction, and the transactions in which tx1, tx2, and tx3 are transferred are later in time and sequential such that the timestamp associated with the transfer of tx1 is earlier than the timestamp associated with the transfer of tx2, which in turn is earlier than the timestamp associated with the transfer of tx3. In freezing tokens across multiple wallets, the amount frozen may be no more than |tx0|, such that the return of the tokens frozen across multiple wallets to the transmitter wallet 1202 returns the transmitter wallet 1202 to its state prior to execution of the transaction with the transmitter wallet 1201.

Transaction processor 116 generally receives a request to perform a transaction involving a transfer of wrapped tokens from a transmitter wallet 120₂ to a transmitter wallet 120₁. The request generally includes information identifying the transmitter wallet 120₁ (e.g., an address of the transmitter wallet), information identifying the transmitter wallet 120₂ (e.g., an address of transmitter wallet), and an amount of a wrapped token to be transferred from the transmitter wallet 120₁ to the transmitter wallet 120₂. Generally, transaction processor can invoke a transfer of tokens from a transmitter wallet 120₂ to a transmitter wallet 120₁ by validating that a sufficient number of tokens exist within the transmitter wallet 120₂ and, if so, invoking a smart contract or other programmatic construct on blockchain 132 that commits a transaction record to the blockchain 132 and causes tokens to be transferred between transmitter wallet 120₂ and transmitter wallet 120₁.

Generally, a policy associated with the recipient wallet 120 may specify whether a transaction can be performed using recoverable tokens (e.g., tokens subject to freezing and transaction reversal by token freezer 114 and/or other governance authorities participating in processing transactions on blockchain 132). If a policy specifies that a transaction can be performed using non-recoverable tokens, transaction processor 116 can examine the nonrecoverable token store 124 of transmitter wallet 120₂ to determine whether a sufficient amount of tokens are available for use in the transaction. In some aspects, if there is an insufficient amount of tokens in nonrecoverable token store 124 to satisfy the transaction, transaction processor 116 can prevent the transaction from being executed and committed to the blockchain 132. In some aspects, if there is an insufficient amount of tokens in nonrecoverable token store 124 to satisfy the transaction, transaction processor 116 can wrap tokens in base token store 126 and move the wrapped tokens to nonrecoverable token store 124 for use in performing the transaction.

If a policy associated with the recipient wallet 120 allows a transaction to be performed using recoverable tokens, transaction processor 116 can examine both the recoverable token store 122 and nonrecoverable token store 124 of transmitter wallet 120₂ to determine if there is a sufficient amount of tokens, in aggregate, to perform the transaction. If there is a sufficient amount of tokens, in aggregate, transaction processor 116 can select the tokens to be transferred from transmitter wallet 120₂ to transmitter wallet 120₁ from one or both of recoverable token store 122 and/or nonrecoverable token store 124. In some aspects, tokens may be transferred from nonrecoverable token store 124 until no tokens exist at nonrecoverable token store 124. Once the supply of tokens in nonrecoverable token store 124 is exhausted, transaction processor 116 can allow for tokens stored in recoverable token store 122 of transmitter wallet 120₂ to also be transferred to receiver wallet 120₁. In some aspects, tokens may be transferred from recoverable token store 122 of transmitter wallet 120₂ until no tokens exist at recoverable token store 122. Once the supply of tokens in recoverable token store 122 is exhausted, transaction processor 116 can allow for tokens stored in nonrecoverable token store 124 of transmitter wallet 120₂ to also be transferred from transmitter wallet 120₂ to receiver wallet 120₁.

### Example Recoverable Transaction Execution on a Blockchain Using Wrapped Tokens

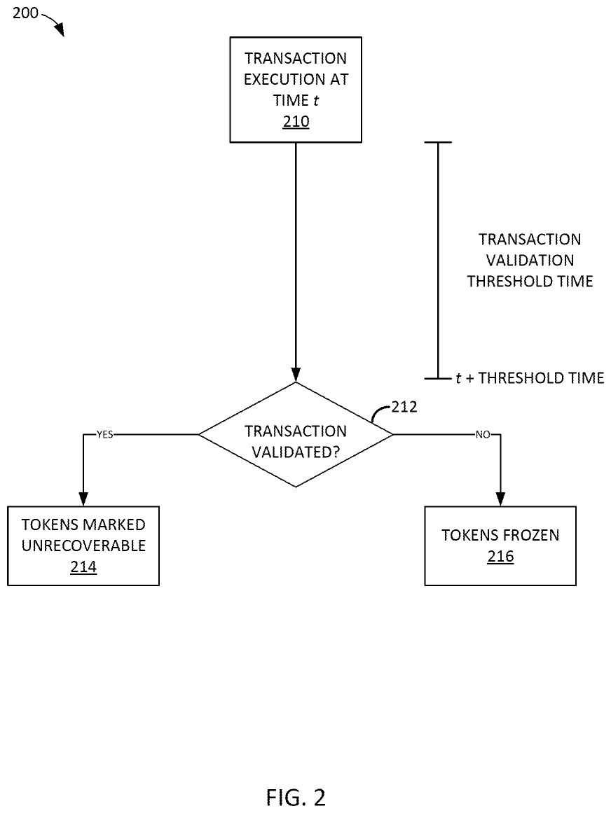

FIG. 2 illustrates a timeline 200 for executing a recoverable transaction on a blockchain using wrapped tokens, according to embodiments of the present disclosure

As illustrated, in timeline 200, a transaction 210 is executed at time 1. The transaction 210, as discussed, generally includes the transfer of tokens from a transmitter wallet to a transmitter wallet (e.g., between wallets 120 illustrated in FIG. 1) and is recorded and processed on a blockchain (e.g., blockchain 132 illustrated in FIG. 1). In executing the transaction 210, wrapped tokens may be transferred from the transmitter wallet to the transmitter wallet. The tokens withdrawn from the transmitter wallet may be tokens in a non-recoverable state or a mix of tokens in a recoverable state and a non-recoverable state, depending on a policy defined for the user associated with the transmitter wallet (e.g., identifying whether the user associated with the transmitter wallet allows for transactions to be performed using wrapped tokens in a recoverable state). When the transaction is executed, a quantity of wrapped tokens are transferred from the transmitter wallet to the transmitter wallet. When received at the transmitter wallet, the received wrapped tokens are placed in a recoverable state (e.g., stored in a portion of a wallet in which recoverable tokens are stored, such as recoverable token store 122 illustrated in FIG. 1) for a threshold amount of time.

Before the threshold amount of time elapses (e.g., before time+threshold_time), a governance authority (e.g., token freezer 114 illustrated in FIG. 1 and/or other governance authorities) can determine that the transaction 210 is fraudulent, malicious activity, or otherwise subject to reversal. If the governance authority (or majority of governance authorities, in a case in which transactions and token freezes are validated on-chain) determines that a transaction is subject to reversal prior to the threshold time elapsing, the governance authority can determine that the tokens associated with the transaction can be frozen for future recovery.

At block 212, occurring one or after t+threshold_time, a transaction processor can determine whether the transaction 210 has been validated as a legitimate transaction or has been determined to be fraudulent, malicious activity, or otherwise subject to reversal. If, at block 212, the transaction processor determines that the transaction 210 has been validated as a legitimate transaction, the transaction processor can mark the tokens involved in transaction 210 as unrecoverable. For example, the tokens may be migrated to a portion of a wallet in which nonrecoverable tokens are stored, or the tokens involved in transaction 210 may have a status indicator updated to reflect that such tokens are now nonrecoverable tokens. The owner of the wallet receiving these tokens may perform subsequent transactions with these nonrecoverable tokens, such as executing further transactions involving the transfer of these nonrecoverable tokens, unwrapping these nonrecoverable tokens into the base token encapsulated therein, or the like.

If, however, at block 212, the transaction processor determines that the transaction 210 is fraudulent, malicious activity, or otherwise subject to reversal, then at block 216, the transaction processor can freeze the tokens associated with transaction 210. In some aspects, a single governance authority (e.g., token freezer 114 illustrated in FIG. 1) can be used to determine that a transaction is subject to reversal. In such a case, token freezer 114 can determine, at any point in time prior to the threshold amount of time elapsing, that a transaction is subject to reversal and can freeze the tokens associated with the transaction 210. That is, it should be understood that while timeline 200 illustrates the determination of a transaction 210 to be subject to reversal after the threshold amount of time has elapsed from the time at which transaction 210 was performed, the transaction can be deemed to be subject to reversal, and the corresponding tokens may be frozen, at any time prior to time/+threshold_time. In some aspects, where transaction reversibility and token freezing is performed based on a consensus derived from determinations by multiple governance authorities, a transaction 210 may be deemed to be subject to reversal if, at any point in time prior to the threshold amount of time elapsing, that a threshold number of governance authorities has determined a transaction to be fraudulent, malicious activity, or otherwise subject to reversal.

After the tokens are frozen at block 216, the tokens can be recovered at the transmitter wallet. To recover the tokens, a subsequent transaction may be recorded on blockchain 132 evidencing that the transaction 210 is being reversed. The tokens may be removed from the transmitter wallet (and potentially from downstream transmitter wallets, as discussed above) and returned to the transmitter wallet through this subsequent transaction recorded on blockchain 132. The tokens removed from the transmitter wallet may, in some aspects, be tokens stored in a nonrecoverable token store and may be the tokens originally transferred to the transmitter wallet (e.g., in a case in which tokens are unique and nonfungible). This subsequent transaction to recover tokens may, in some cases, not be subject to a waiting period before the tokens involved in this subsequent transaction are deemed nonrecoverable; rather, based on determining that the tokens were transferred as part of a recoverable transaction, the tokens returned to the transmitter wallet may be returned in a nonrecoverable state and made available for subsequent use.

### Example Operations for Recoverable Transaction Processing on a Blockchain Using Wrapped Tokens

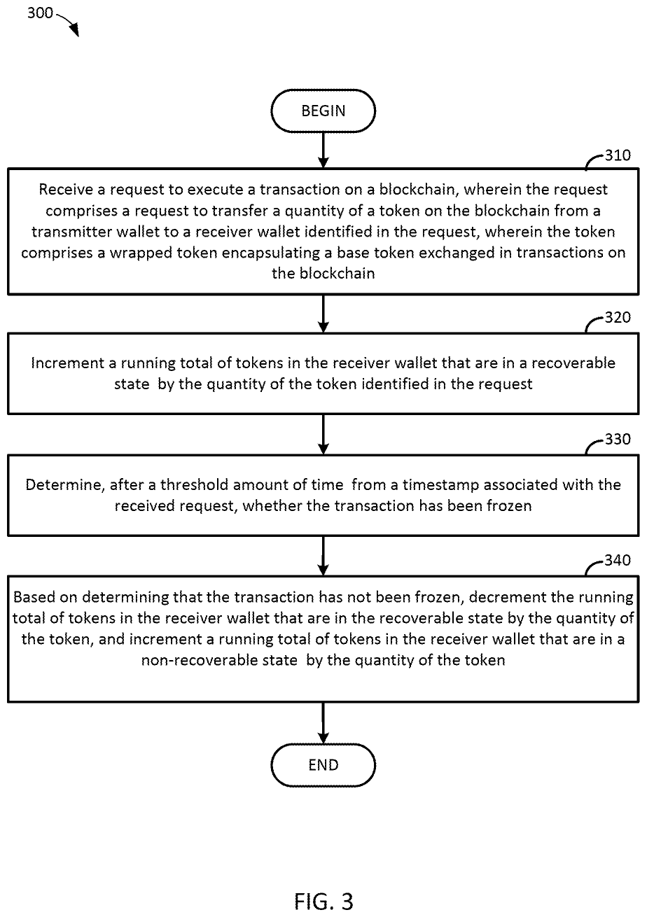

FIG. 3 illustrates example operations 300 for executing a recoverable transaction on a blockchain, according to embodiments of the present disclosure. Operations 300 may be performed, for example, by a transaction processing system (e.g., transaction processing system 110 illustrated in FIG. 1) that users associated with a transmitter wallet and a receiver wallet use to execute recoverable transactions on a blockchain.

Operations 300 begin, as illustrated, at block 310, with receiving a request to execute a transaction on a blockchain. The request generally includes a request to transfer a quantity of a token on the blockchain from a transmitter wallet to a receiver wallet identified in the request. The token may be a wrapped token encapsulating a base token exchanged in transactions on the blockchain.

At block 320, operations 300 proceed with incrementing a running total of tokens in the receiver wallet that are in a recoverable state by the quantity of the token identified in the request

At block 330, operations 300 proceed with determining, after a threshold amount of time from a timestamp associated with the received request, whether the transaction has been frozen.

At block 340, operations 300 proceed with, based on determining that the transaction has not been frozen, decrementing the running total of tokens in the receiver wallet that are in the recoverable state by the quantity of the token, and incrementing a running total of tokens in the receiver wallet that are in a non-recoverable state by the quantity of the token.

In some aspects, incrementing the running total of tokens in the receiver wallet that are in the recoverable state includes transferring, from the transmitter wallet to the receiver wallet, the quantity of the token into a portion of the receiver wallet in which tokens in the recoverable state are stored.

In some aspects, the quantity of the token may be drawn from tokens in the non-recoverable state in the transmitter wallet. In some aspects, transferring the quantity of the token may include transmitting a first quantity of the token from tokens in the non-recoverable state in the transmitter wallet before transmitting a second quantity of the token from tokens in the recoverable state. The sum of the first quantity of the token and the second quantity of the token equals the quantity of the token, and the first quantity of the token is less than the quantity of the token.

In some aspects, the quantity of the token may be drawn from tokens in the recoverable state in the transmitter wallet. Transferring the quantity of the token may include transmitting a first quantity of the token from tokens in the recoverable state in the transmitter wallet before transmitting a second quantity of the token from tokens in the non-recoverable state. The sum of the first quantity of the token and the second quantity of the token equals the quantity of the token, and the first quantity of the token is less than the quantity of the token.

In some aspects, a policy associated with the receiver wallet identifies whether the quantity of the token can be withdrawn from a portion of the transmitter wallet in which tokens in the recoverable state are stored. Operations 300 may further include determining, based on records stored on the blockchain, a first amount of tokens in a non-recoverable state in the transmitter wallet and a second amount of tokens in a recoverable state in the transmitter wallet. Generally, the second amount of tokens in the recoverable state may be identified based on transaction records on the blockchain associated with transactions for which the threshold amount of time has not elapsed

In some aspects, operations 300 further include incrementing a running total of tokens in the receiver wallet that are in a frozen state by the quantity of the token based on determining that the transaction has been frozen.

In some aspects, operations 300 further include receiving, from a defined governance source, an indication that the transaction is to be reversed. Based on the received indication, the quantity of the token is restored to the transmitter wallet.

In some aspects, to restore the quantity of the token to the transmitter wallet, a chain of wallets including the receiver wallet is identified. The chain of wallets may generally correspond to wallets into which tokens associated with the transaction were transferred. These wallets may be identified based on timestamps associated with a series of transactions such that a total amount of tokens frozen across the chain of wallets equals the quantity of the token. Tokens are transferred from the chain of wallets to the transmitter wallet. In some aspects, the series of transactions comprises a chain of transactions ordered sequentially in time and performed subsequent to the transaction.

### Example System for Recoverable Transaction Processing on a Blockchain Using Wrapped Tokens

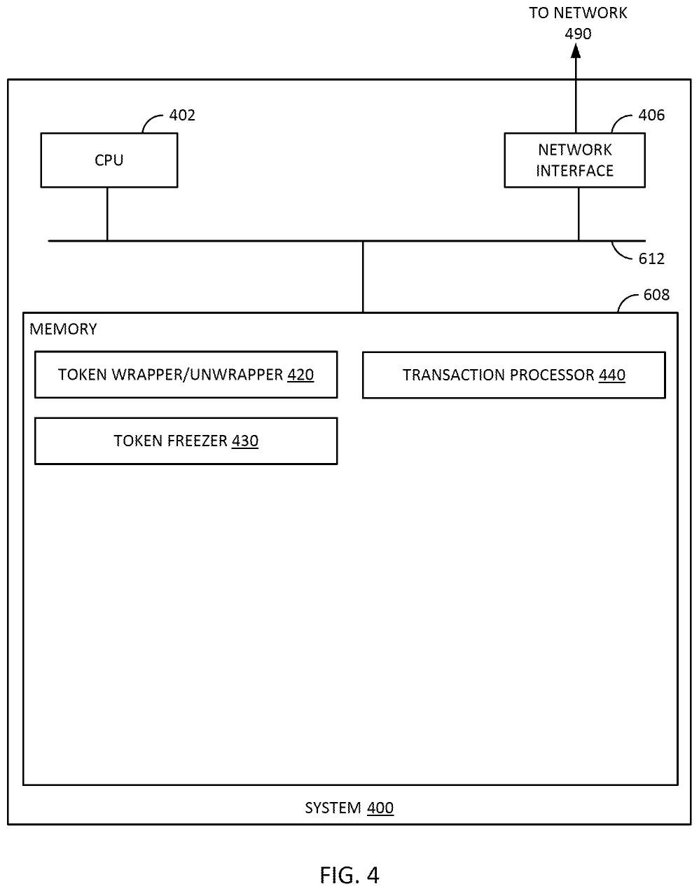

FIG. 4 illustrates an example system 400 configured to perform the methods described herein, including, for example, operations 300 of FIG. 3. In some embodiments, system 400 may act as a transaction processing service which receives requests to transfer tokens between transmitting and transmitter wallets and commit records of such transactions to a blockchain, such as transaction processing system 110 illustrated in FIG. 1.

As shown, system 400 includes a central processing unit (CPU) 402, one or more I/O device interfaces 404 that may allow for the connection of various I/O devices 414 (e.g., keyboards, displays, mouse devices, pen input, etc.) to the system 400, network interface 406 through which system 400 is connected to network 690 (which may be a local network, an intranet, the internet, or any other group of computing devices communicatively connected to each other), a memory 408, and an interconnect 412. The I/O devices 414 and/or network interface 406 may be used to receive requests to bridge transactions between different blockchains, such as a Layer 1 blockchain and a Layer 2 blockchain.

CPU 402 may retrieve and execute programming instructions stored in the memory 408. Similarly, the CPU 402 may retrieve and store application data residing in the memory 408. The interconnect 412 transmits programming instructions and application data, among the CPU 402, I/O device interface 404, network interface 406, and memory 408.

CPU 402 is included to be representative of a single CPU, multiple CPUs, a single CPU having multiple processing cores, and the like.

Memory 408 is representative of a volatile memory, such as a random access memory, or a nonvolatile memory, such as nonvolatile random access memory, phase change random access memory, or the like. As shown, memory 408 includes a token wrapper/unwrapper 420, token freezer 430, and transaction processor 440.

Token wrapper/unwrapper 420 may correspond to token wrapper/unwrapper 112 illustrated in FIG. 1. Generally, token wrapper/unwrapper 420 creates wrapped tokens from a base token and unwraps base tokens from wrapped tokens. In creating a wrapped token, token wrapper/unwrapper 420 encapsulates a base token, which may be a token used in transactions performed and recorded on a blockchain, and adds additional features that allow for the base token to be placed in a recoverable or unrecoverable state and in a frozen state when tokens are transferred in a transaction marked as fraudulent, a result of malicious activity, or otherwise subject to reversal. Generally, token wrapper/unwrapper 420 may allow for tokens to be unwrapped into a base token when such tokens are in a nonrecoverable state, but may not allow for tokens to be unwrapped when such tokens are in a recoverable state (as these tokens may be associated with transactions that are subject to reversal and thus may be tokens that may be returned to the transmitter wallet).

Token freezer 430 may correspond to token freezer 114 illustrated in FIG. 1. Generally, token freezer 430 serves as a governance authority for transactions recorded on the blockchain to allow for transactions to be marked as fraudulent, malicious activity, or otherwise subject to reversal and to allow for the tokens transferred in these transactions to be frozen pending further review and/or returned to the transmitter wallet. Generally, token freezer 430 may determine that a transaction is subject to reversal, and thus that the associated tokens should be frozen pending a return of such tokens to the receiver wallet, at any time prior to an expiry time defined based on a timestamp associated with the transaction and a threshold amount of time to wait for a transaction to be verified (or for the transaction to be marked as subject to reversal). If token freezer 430 does not mark a transaction as subject to reversal before the expiry time, the transaction may be finalized, and the tokens transferred as part of the transaction may be migrated from a recoverable state to a nonrecoverable state. Otherwise, the transaction may be finalized, and the tokens may be moved from a recoverable token store to a nonrecoverable token store.

Transaction processor 440 may correspond to transaction processor 116 illustrated in FIG. 1. Generally, transaction processor 440 executes transactions on a blockchain and effectuates the transfer of tokens from a transmitter wallet to a receiver wallet. Generally, tokens transferred to the receiver wallet may be transferred in a recoverable state and may be migrated to a nonrecoverable state if a timer associated with a transaction expires. Transaction processor 440 can select the tokens to exchange between transmitter and receiver wallets based on various techniques, such as transferring only tokens that are in a nonrecoverable state or transferring tokens in a nonrecoverable state prior to transferring tokens that are in a recoverable state. Transaction processor 440 may also perform transactions to recover frozen tokens that are associated with transactions deemed by a governance authority (e.g., token freezer 430 and/or other governance authorities).

### Example Clauses

Implementation details for various aspects of the present disclosure are described in the following numbered clauses.
Clause 1: A computer-implemented method, comprising: receiving a request to execute a transaction on a blockchain, wherein the request comprises a request to transfer a quantity of a token on the blockchain from a transmitter wallet to a receiver wallet identified in the request, wherein the token comprises a wrapped token encapsulating a base token exchanged in transactions on the blockchain; incrementing a running total of tokens in the receiver wallet that are in a recoverable state by the quantity of the token identified in the request; determining, after a threshold amount of time from a timestamp associated with the received request, whether the transaction has been frozen; and based on determining that the transaction has not been frozen: decrementing the running total of tokens in the receiver wallet that are in the recoverable state by the quantity of the token, and incrementing a running total of tokens in the receiver wallet that are in a non-recoverable state by the quantity of the token.
Clause 2: The method of Clause 1, further comprising based on determining that the transaction has been frozen, incrementing a running total of tokens in the receiver wallet that are in a frozen state by the quantity of the token.
Clause 3: The method of Clause 2, further comprising: receiving, from a defined governance source, an indication that the transaction is to be reversed; and based on the received indication, restoring the quantity of the token to the transmitter wallet.
Clause 4: The method of Clause 3, wherein restoring the quantity of the token to the receiver wallet comprises: identifying a chain of wallets, including the receiver wallet, in which tokens associated with the transaction were transferred based on timestamps associated with a series of transactions such that a total amount of tokens frozen across the chain of wallets equals the quantity of the token; and transferring tokens from the chain of wallets to the transmitter wallet.
Clause 5: The method of Clause 4, wherein the series of transactions comprises a chain of transactions ordered sequentially in time and performed subsequent to the transaction.
Clause 6: The method of any one of Clauses 1 through 5, wherein incrementing the running total of tokens in the receiver wallet that are in the recoverable state comprises transferring, from the transmitter wallet to the receiver wallet, the quantity of the token into a portion of the receiver wallet in which tokens in the recoverable state are stored.
Clause 7: The method of Clause 6, wherein transferring the quantity of the token comprises transmitting the quantity of the token from tokens in the non-recoverable state in the transmitter wallet.
Clause 8: The method of any one of Clauses 6 or 7, wherein: transferring the quantity of the token comprises transmitting a first quantity of the token from tokens in the recoverable state in the transmitter wallet before transmitting a second quantity of the token from tokens in the non-recoverable state, a sum of the first quantity of the token and the second quantity of the token equals the quantity of the token; and the first quantity of the token is less than the quantity of the token.
Clause 9: The method of any one of Clauses 6 through 8, wherein a policy associated with the receiver wallet identifies whether the quantity of the token can be withdrawn from a portion of the transmitter wallet in which tokens in the recoverable state are stored.
Clause 10: The method of any one of Clauses 1 through 9, further comprising determining, based on records stored on the blockchain, a first amount of tokens in a non-recoverable state in the transmitter wallet and a second amount of tokens in a recoverable state in the transmitter wallet, wherein the second amount of tokens in the recoverable state are identified based on transaction records on the blockchain associated with transactions for which the threshold amount of time has not elapsed.
Clause 11: A system, comprising: a memory having executable instructions stored thereon; and a processor configured to execute the executable instructions to perform the operations of any one of Clauses 1 through 10.
Clause 12: A system, comprising: means for performing the operations of any one of Clauses 1 through 10.
Clause 13: A computer-readable medium having instructions stored thereon which, when executed by a processor, performs the operations of any one of Clauses 1 through 10.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
receiving a request to execute a transaction on a blockchain, wherein the request comprises a request to transfer a quantity of a token on the blockchain from a transmitter wallet to a receiver wallet identified in the request, wherein the token comprises a wrapped token encapsulating a base token exchanged in transactions on the blockchain;
incrementing a running total of tokens in the receiver wallet that are in a recoverable state by the quantity of the token identified in the request;
determining, after a threshold amount of time from a timestamp associated with the received request, whether the transaction has been frozen; and
based on determining that the transaction has not been frozen:
decrementing the running total of tokens in the receiver wallet that are in the recoverable state by the quantity of the token, and
incrementing a running total of tokens in the receiver wallet that are in a non-recoverable state by the quantity of the token.

2. The method of claim 1, further comprising based on determining that the transaction has been frozen, incrementing a running total of tokens in the receiver wallet that are in a frozen state by the quantity of the token.

3. The method of claim 2, further comprising:
receiving, from a defined governance source, an indication that the transaction is to be reversed; and
based on the received indication, restoring the quantity of the token to the transmitter wallet.

4. The method of claim 3, wherein restoring the quantity of the token to the receiver wallet comprises:
identifying a chain of wallets, including the receiver wallet, in which tokens associated with the transaction were transferred based on timestamps associated with a series of transactions such that a total amount of tokens frozen across the chain of wallets equals the quantity of the token; and
transferring tokens from the chain of wallets to the transmitter wallet.

5. The method of claim 4, wherein the series of transactions comprises a chain of transactions ordered sequentially in time and performed subsequent to the transaction.

6. The method of claim 1, wherein incrementing the running total of tokens in the receiver wallet that are in the recoverable state comprises transferring, from the transmitter wallet to the receiver wallet, the quantity of the token into a portion of the receiver wallet in which tokens in the recoverable state are stored.

7. The method of claim 6, wherein transferring the quantity of the token comprises transmitting the quantity of the token from tokens in the non-recoverable state in the transmitter wallet.

8. The method of claim 6, wherein:
transferring the quantity of the token comprises transmitting a first quantity of the token from tokens in the recoverable state in the transmitter wallet before transmitting a second quantity of the token from tokens in the non-recoverable state,
a sum of the first quantity of the token and the second quantity of the token equals the quantity of the token; and
the first quantity of the token is less than the quantity of the token.

9. The method of claim 6, wherein a policy associated with the receiver wallet identifies whether the quantity of the token can be withdrawn from a portion of the transmitter wallet in which tokens in the recoverable state are stored.

10. The method of claim 1, further comprising determining, based on records stored on the blockchain, a first amount of tokens in a non-recoverable state in the transmitter wallet and a second amount of tokens in a recoverable state in the transmitter wallet, wherein the second amount of tokens in the recoverable state are identified based on transaction records on the blockchain associated with transactions for which the threshold amount of time has not elapsed.

11. A system, comprising:
a memory having executable instructions stored thereon; and
a processor configured to execute the executable instructions in order to cause the system to:
receive a request to execute a transaction on a blockchain, wherein the request comprises a request to transfer a quantity of a token on the blockchain from a transmitter wallet to a receiver wallet identified in the request, wherein the token comprises a wrapped token encapsulating a base token exchanged in transactions on the blockchain;
increment a running total of tokens in the receiver wallet that are in a recoverable state by the quantity of the token identified in the request;
determine, after a threshold amount of time from a timestamp associated with the received request, whether the transaction has been frozen; and
based on a determination that the transaction has not been frozen:
decrement the running total of tokens in the receiver wallet that are in the recoverable state by the quantity of the token, and
increment a running total of tokens in the receiver wallet that are in a non-recoverable state by the quantity of the token.

12. The system of claim 11, wherein the processor is further configured to cause the system to increment, based on a determination that the transaction has been frozen, a running total of tokens in the receiver wallet that are in a frozen state by the quantity of the token.

13. The system of claim 12, wherein the processor is further configured to cause the system to:
receive, from a defined governance source, an indication that the transaction is to be reversed; and
based on the received indication, restore the quantity of the token to the transmitter wallet.

14. The system of claim 13, wherein in order to restore the quantity of the token to the receiver wallet, the processor is configured to cause the system to:
identify a chain of wallets, including the receiver wallet, in which tokens associated with the transaction were transferred based on timestamps associated with a series of transactions such that a total amount of tokens frozen across the chain of wallets equals the quantity of the token; and
transfer tokens from the chain of wallets to the transmitter wallet.

15. The system of claim 11, wherein in order to increment the running total of tokens in the receiver wallet that are in the recoverable state, the processor is configured to cause the system to transfer, from the transmitter wallet to the receiver wallet, the quantity of the token into a portion of the receiver wallet in which tokens in the recoverable state are stored.

16. The system of claim 15, wherein in order to transfer the quantity of the token, the processor is configured to cause the system to transmit the quantity of the token from tokens in the non-recoverable state in the transmitter wallet.

17. The system of claim 15, wherein:
in order to transfer the quantity of the token, the processor is configured to cause the system to transmit a first quantity of the token from tokens in the recoverable state in the transmitter wallet before transmitting a second quantity of the token from tokens in the non-recoverable state,
a sum of the first quantity of the token and the second quantity of the token equals the quantity of the token; and
the first quantity of the token is less than the quantity of the token.

18. The system of claim 15, wherein a policy associated with the receiver wallet identifies whether the quantity of the token can be withdrawn from a portion of the transmitter wallet in which tokens in the recoverable state are stored.

19. The system of claim 11, wherein the processor is further configured to cause the system to determine, based on records stored on the blockchain, a first amount of tokens in a non-recoverable state in the transmitter wallet and a second amount of tokens in a recoverable state in the transmitter wallet, wherein the second amount of tokens in the recoverable state are identified based on transaction records on the blockchain associated with transactions for which the threshold amount of time has not elapsed.

20. A computer-readable medium having instructions stored thereon which, when executed by a processor, performs an operation comprising:
receiving a request to execute a transaction on a blockchain, wherein the request comprises a request to transfer a quantity of a token on the blockchain from a transmitter wallet to a receiver wallet identified in the request, wherein the token comprises a wrapped token encapsulating a base token exchanged in transactions on the blockchain;
incrementing a running total of tokens in the receiver wallet that are in a recoverable state by the quantity of the token identified in the request;
determining, after a threshold amount of time from a timestamp associated with the received request, whether the transaction has been frozen; and
based on determining that the transaction has not been frozen:
decrementing the running total of tokens in the receiver wallet that are in the recoverable state by the quantity of the token, and
incrementing a running total of tokens in the receiver wallet that are in a non-recoverable state by the quantity of the token.
